(19) United States
(12) Patent Application Publication
(10) Pub. No.: US 2007/0203670 A1
(43) Pub. Date: Aug. 30, 2007

(54) System for automatic authorization and notification of transmitted data

(75) Inventor: Kevin Christopher Earle, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/363,254

(22) Filed: Feb. 28, 2006

(51) Int. Cl. G06F 11/00

(52) U.S. Cl. 702/188

(57) ABSTRACT

A data acquisition system for a machine is disclosed. The data acquisition system has an interface control module located on the machine and an offboard data system in communication with the interface control module. The interface control module is configured to collect information related to performance of the machine. The offboard data system is configured to receive a request for the information collected by the interface control module and determine whether a current user of the machine is a new user or an existing user. The offboard data system is further configured to initiate an authorization process associated with communication of the requested information in response to the determination.

### TECHNICAL FIELD

This disclosure relates generally to an automatic data system for a machine and, more particularly, to a machine system that automatically verifies authorization for and automatically provides notification of an intended data transmission.

### BACKGROUND

Machines such as, for example, construction equipment, passenger vehicles, vocational trucks, and other machines known in the art are often equipped with systems capable of transmitting data from the machine to an offboard location. The data may include operational information associated with the machine such as component health of the machine, operational characteristics of the machine, performance of the machine, and other such pieces of information. This information may be valuable to an operator or owner of the machine, a dealership responsible for servicing the machine, a manufacturer of the machine, and competing machine operators or owners.

One example of such a machine monitoring system is described in U.S. Pat. No. 5,463,567 (the '567 patent) issued to Boen et al. on Oct. 31, 1995. The '567 patent describes a machine monitoring system for providing historical data regarding machine operating parameters. The machine monitoring system includes a plurality of sensors for producing signals indicative of the level of machine parameters. A control is included for processing the signals to provide an indication of machine performance. The processed data is then sent to an offboard system via either a direct physical communication link or by telemetry.

Although the machine monitoring system of the '567 patent may sufficiently gather, process, and transmit machine related data to an offboard system, it may do little to ensure the privacy of the transmitted data. In particular, the machine monitoring system of the '567 patent may transmit the collected and processed machine data regardless of authorization to do so. Some transmissions could be undesired by and potentially damaging to the owner of the machine. This situation may be compounded further when the machine is transferred from a first owner to a second owner and previously established transmission authorization has not been updated to reflect the transference, or referenced during the transmission.

The system of the present disclosure is directed towards overcoming one or more of the problems as set forth above.

### SUMMARY OF THE INVENTION

In accordance with one aspect, the present disclosure is directed toward a data acquisition system for a machine. The data acquisition system includes an interface control module located on the machine and configured to collect information related to performance of the machine, and an offboard data system in communication with the interface control module. The offboard data system is configured to receive a request for the information collected by the interface control module and determine whether a current user of the machine is a new user or an existing user. The offboard data system is further configured to initiate an authorization process associated with communication of the requested information in response to the determination.

According to another aspect, the present disclosure is directed toward a method of communicating data from a machine. The method includes collecting information related to performance of the machine, and receiving a request for the collected information from offboard the machine. The method also includes determining whether a current user of the machine is a new user or an existing user, and initiating an authorization process in response to the determination.

### BRIEF DESCRIPTION OF THE DRAWINGS

FIG. 1 is a pictorial illustration of an exemplary disclosed machine traveling between adjacent worksites;

FIG. 2 is a schematic and diagrammatic illustration of an exemplary disclosed data acquisition system for use with the machine of FIG. 1; and

FIG. 3 is a flowchart illustrating an exemplary disclosed method of operating the data acquisition system of FIG. 2.

### DETAILED DESCRIPTION

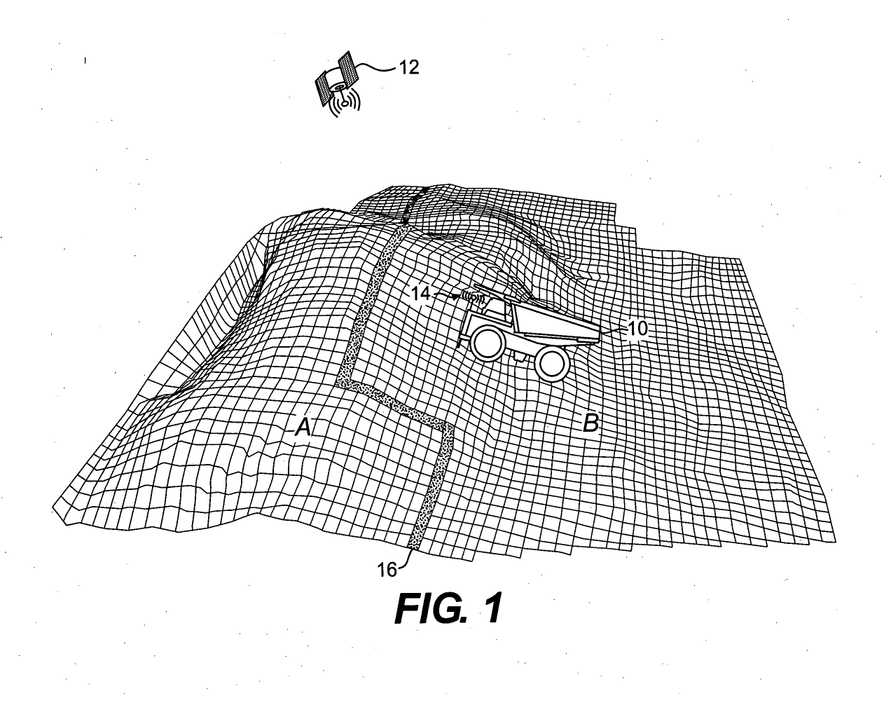

FIG. 1 illustrates an exemplary machine 10 traveling between adjacent worksites A and B. Each worksite may include, for example, a mine site, a landfill, a quarry, a construction site, a dealership coverage area, or any other type of worksite known in the art. As machine 10 travels or is otherwise transported from worksite B to worksite A or in reverse direction from A to B, a satellite 12 or other tracking device may communicate with an onboard locating device 14 to monitor the movement of machine 10. During this travel between worksites, machine 10 may cross a virtual fence 16 also known as a “geo-fence” that separates worksite A from worksite B.

Machine 10 may embody a stationary or mobile machine configured to perform some type of operation associated with an industry such as mining, construction, farming, transportation, power generation, or any other industry known in the art. For example, machine 10 may be an earth moving machine such as the haul truck pictured in FIG. 1, a dozer, a loader, a backhoe, an excavator, a motor grader, or any other earth moving machine. Machine 10 may alternatively embody a non-earth moving machine such as a passenger vehicle, a stationary generator set, a pumping mechanism, or any other suitable operation-performing machine.

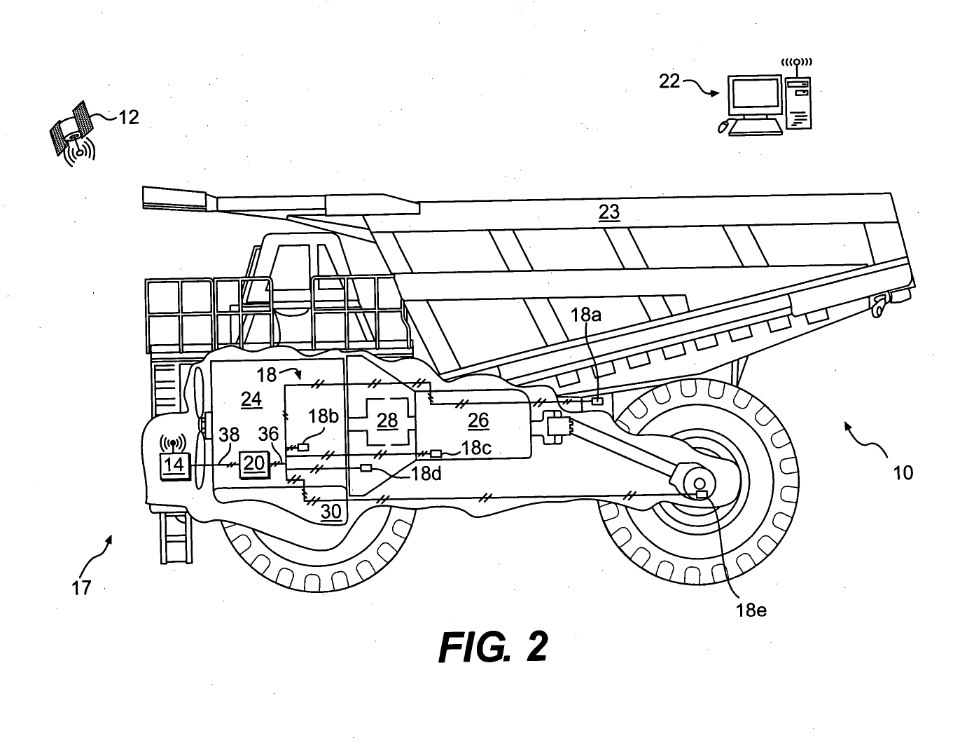

FIG. 2 illustrates machine 10 having an interface control system 17 with components that cooperate to automatically acquire data from machine 10 during operation of machine 10. For example, interface control system 17 may include locating device 14, an interface control module 18, and a controller 20 configured to communicate with an offboard system 22. It is contemplated that one or more of locating device 14, interface control module 18, and controller 20 may be integrated as a single unit, if desired. It is further contemplated that interface control system 17 may include additional or different components than those illustrated in FIG. 2.

Locating device 14 may be configured to determine a position of machine 10 and generate a signal indicative thereof. For example, locating device 14 could embody a Global Positioning System (GPS), an Inertial Reference Unit (IRU), a local tracking system, or any other known locating device that receives or determines positional information associated with machine 10. Locating device 14 may be in communication with controller 20 to convey a signal indicative of the received or determined positional information to offboard system 22.

Interface control module 18 may include a plurality of sensing devices 18a-e distributed throughout machine 10 and configured to gather data from various components and systems of machine 10. Sensing devices 18a-e may be associated with, for example, a work implement 23, a power source 24, a transmission 26, a torque converter 28, a fluid supply 30, and/or other components and subsystems of machine 10. These sensing devices 18a-e may automatically gather data from machine 10 such as implement, engine, and/or machine speed or location; fluid pressure, flow rate, temperature, contamination level, and/or viscosity; electric current and/or voltage levels; fluid (i.e., fuel, oil, etc.) consumption rates; loading levels (i.e., payload value, percent of maximum allowable payload limit, payload history, payload distribution, etc.); transmission output ratio; cycle time; grade; recently performed maintenance and/or repair operations; and other such pieces of information. Additional information may be generated or maintained by interface control module 18 such as the date, time of day, and operator information. The gathered data may be indexed relative to the time, day, date, operator information, or other pieces of information to trend the various operational aspects of machine 10, if desired.

Controller 20 may include any means for monitoring, recording, storing, indexing, processing, and/or communicating the operational aspects of machine 10 described above. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

Controller 20 may further include a means for communicating with offboard system 22. For example, controller 20 may include hardware and/or software that enables sending and receiving of data messages through a direct data link (not shown) or a wireless communication link (not shown). The wireless communications may include satellite, cellular, infrared, and any other type of wireless communications that enable controller 20 to exchange information with offboard system 22. It is contemplated that a separate module may alternatively be included within interface control system 17 to facilitate the communication of data between controller 20 and offboard system 22, if desired.

Controller 20 may also communicate with the other components of interface control system 17. For example, controller 20 may communicate with interface control module 18 and locating device 14 via communication lines 36 and 38, respectively. Controller 20 may send communications to and receive communications from offboard system 22 in response to input from interface control module 18 and/or locating device 14. Conversely, controller 20 may monitor and/or control operation of interface control module 18 and/or locating device 14 in response to communications from offboard system 22. Various other known circuits may also be associated with controller 20 such as, for example, power supply circuitry, signal-conditioning circuitry, solenoid driver circuitry, communication circuitry, and other appropriate circuitry.

Offboard system 22 may represent one or more receiving and computing systems of a business entity associated with machine 10, such as a manufacturer, dealer, retailer, owner, service provider, or any other entity that generates, maintains, sends, and/or receives information associated with machine 10. The one or more computing systems may include, for example, a laptop, a work station, a personal digital assistant, a mainframe, and other computing systems known in the art.

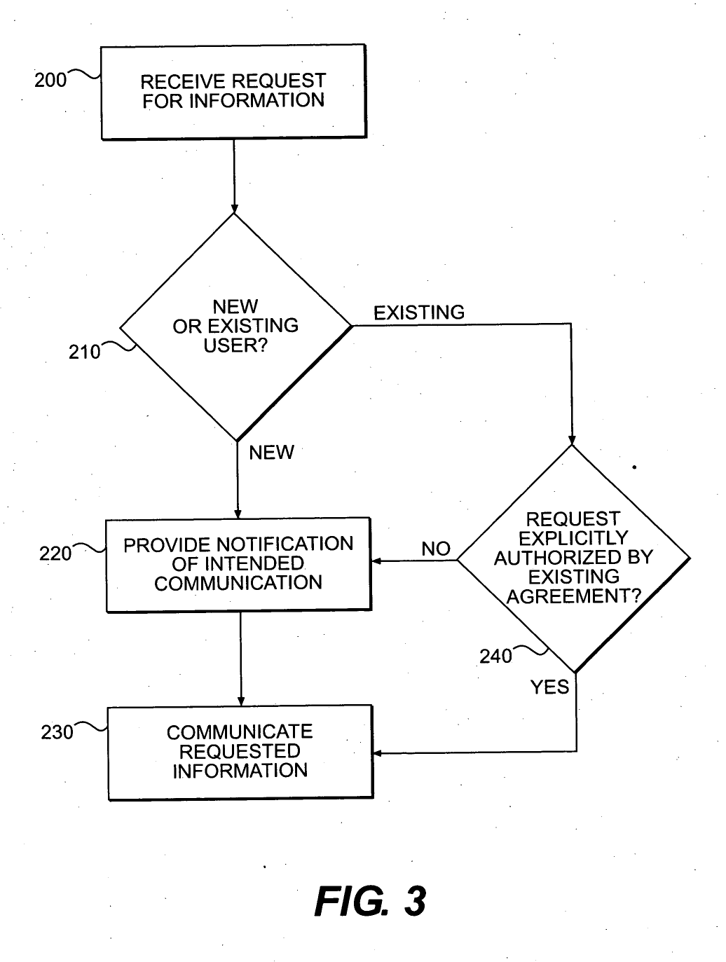

FIG. 3 illustrates a flowchart depicting a method of communicating operational information associated with machine 10 in response to a request for information. FIG. 3 will be discussed in the following section to further illustrate the disclosed system and its operation.

### INDUSTRIAL APPLICABILITY

The disclosed system may provide a secure method of communicating requested operational information associated with a machine from a component onboard the machine to an offboard system. In particular, the disclosed method and system may receive a request for operational information acquired by the component, determine an authorization status associated with the request, and respond accordingly. The data transmission authorization processes will now be described.

As illustrated in the flowchart of FIG. 3, the first step in the transmission authorization process may include receiving a request for communication of information collected by interface control module 18 (Step 200). The request may include, among other things, instructions regarding what specific operational information is desired, the date on which the information is to be collected, the time of day intended for the collection, a sampling interval, an analysis that is to be performed on the collected information, and other similar characteristics associated with machine data. The request may also contain information regarding the destination to which the information is to be communicated, and the date, time of day, and frequency at which the transmission(s) is to occur.

After receiving the request for communication of machine related information, offboard system 22 may determine if the current user of machine 10 is a new user or an existing user (Step 210). Offboard system 22 may determine whether the current user is new or existing in a number of different ways. First, offboard system 22 may be configured to receive a manual indication that a transference of machine 10 (e.g., a sale, lease, loan, etc.) from an existing user to a new user has occurred. The manual indication may include one of the two parties involved in the transference of machine 10 (e.g., either the original transferring party or the new party responsible for receiving machine 10) manually providing to offboard system 22 notification of the transference. It is contemplated that the notification of transference may be manually provided by an operator of machine 10 from within machine 10 by way of, for example, a control device associated with an operator station of machine 10, by telephone, email, hard copy, or in any other suitable manner.

Second, offboard system 22 may be configured to automatically detect whether the current user of machine 10 is new to machine 10. Offboard system 22 may automatically detect whether the current user is a new user by monitoring a global position of machine 10 via locating device 14, and comparing the monitored global position to a geographical area of authorized operation associated with the current user of work machine. If this comparison performed by offboard system 22 reveals that machine 10 has crossed virtual fence 16 and is operating outside of the geographical area of authorized operation, it can be concluded that the current user of machine 10 is a new user. It is also contemplated the status of the current user may alternatively be automatically detected by comparing changes in techniques of operating machine 10, by comparing differences in monitored terrain over which machine 10 has been and is currently operating, or in any other similar manner.

In response to the determination made in step 210, offboard system may initiate a data transmission authorization process. For example, if it is determined that the current user of machine 10 is a new user, offboard system may be configured to provide notification to the new user of the intent to transmit the requested information (Step 220). Offboard system 22 may notify the current user of the intended communication via telephone, email, wireless signal to an operator station of machine 10, hard copy, or in any other appropriate manner. The notification may include any one or all of the details associated with the request for communication. In addition, it is contemplated that the new user of machine 10 may, at the time of notification, be given the opportunity to abort the communication, if desired. Following notification, communication of the requested information may commence (Step 230). Once the requested, communication is complete, control may return to step 200 to await the next request for information.

If, however, offboard system 22 determines that the current user of machine 10 is an existing user, offboard system may determine whether communication of the requested information has been explicitly authorized by the current user (Step 240). This determination may be accomplished by offboard system 22 comparing details of the request to an agreement previously executed by the current user of machine 10. The agreement may be electronically represented within the database of offboard system 22 and executed at the time of sale or transference of machine 10.

If the comparison indicates that communication of the information in the manner requested (e.g., type of information, date, time of day, sampling interval, communication destination, etc.) has been explicitly authorized by the current user of machine 10, offboard system 22 may then communicate the requested information (Step 230) without providing notification to the current user. Once the requested communication is complete, control may return to step 200 to await the next request for information. However, if, during step 240, it is determined that communication of the requested information has not been explicitly authorized, control may be routed through step 220 such that notification of the intended communication is provided to the current user of machine 10.

In this manner, requested information may only be communicated from machine 10 to offboard system 22 if a current user of machine has explicitly authorized such a communication or if the current user of machine 10 is notified of the intended communication. This practice may help to protect the rights of a new machine user in situations where the authorization agreement stored within the database of offboard system 22 may not yet be updated to reflect a recent transference of machine 10 and desires of the new user with regard to information communications. This practice may also help to protect the rights of an existing user of machine 10 where particular communications have not been previously authorized by and could be potentially damaging to the existing user.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A data acquisition system for a machine, comprising:
an interface control module located on the machine and configured to collect information related to performance of the machine; and
an offboard data system in communication with the interface control module and being configured to:
receive a request for the information collected by the interface control module;
determine whether a current user of the machine is a new user or an existing user; and
initiate an authorization process associated with communication of the requested information in response to the determination.

2. The data acquisition system of claim 1, wherein the authorization process includes comparing details of the request for information with a previously executed agreement.

3. The data acquisition system of claim 1, wherein the authorization process includes providing notification to the current user of the machine of an intent to communicate the requested information.

4. The data acquisition system of claim 3, wherein the notification includes a signal sent to an operator station of the machine.

5. The data acquisition system of claim 1, wherein the offboard system is configured to determine whether the current user is a new user or an existing user by monitoring an operational characteristic of the machine.

6. The data acquisition system of claim 5, wherein the operational characteristic includes a global position of the machine.

7. The data acquisition system of claim 5, wherein the operational characteristic includes a technique in which the machine is operated.

8. The data acquisition system of claim 1, wherein the offboard system is configured to determine whether the current user is a new user or an existing user by receiving a manual indication that a transference of the machine has occurred.

9. The data acquisition system of claim 1, wherein the offboard system if further configured to communicate the requested information following completion of the authorization process.

10. A method of communicating data from a machine, comprising:
collecting information related to performance of the machine;
receiving a request for the collected information from offboard the machine;
determining whether a current user of the machine is a new user or an existing user; and
initiating an authorization process in response to the determination.

11. The method of claim 10, wherein initiating an authorization process includes comparing details of the request for information with a previously executed agreement.

12. The method of claim 10, wherein initiating an authorization process includes providing notification to the current user of the machine of an intent to communicate the requested information.

13. The method of claim 10, wherein the step of determining whether a current user of the machine is a new user or an existing user includes monitoring an operational characteristic of the machine.

14. The method of claim 10, further including communicating the requested information following completion of the authorization process.

15. A machine, comprising:
a power source configured to produce a power output;
an interface control module configured to monitor and collect information related to performance of the power source; and
an offboard data system in communication with the interface control module and being configured to:
receive a request for the information collected by the interface control module;
determine whether a current user of the machine is a new user or an existing user;
initiate an authorization process associated with communication of the requested information in response to the determination; and
communicate the requested information following completion of the authorization process.

16. The machine of claim 15, wherein the authorization process includes comparing details of the request for information with a previously executed agreement.

17. The machine of claim 15, wherein the authorization process includes providing notification to the current user of the machine of an intent to communicate the requested information.

18. The machine of claim 15, wherein the offboard system is configured to determine whether the current user is a new user or an existing user by monitoring an operational characteristic of the machine.

19. The machine of claim 18, wherein the operational characteristic includes at least one of:
a global position of the machine; and
a technique in which the machine is operated.

20. The machine of claim 15, wherein the offboard system is configured to determine whether the current user is a new user or an existing user by receiving a manual indication that a transference of the machine has occurred.
